(19) United States
(12) Patent Application Publication
(10) Pub. No.: US 2012/0327136 A1
(43) Pub. Date: Dec. 27, 2012

(54) DISPLAY DEVICE

(75) Inventors: Kazuhiro Uehara, Osaka-shi (JP); Toshiyuki Gotoh, Osaka-shi (JP)

(73) Assignee: Sharp Kabushiki Kaisha, Osaka (JP)

(21) Appl. No.: 13/583,130

(22) PCT Filed: Jan. 7, 2011
(86) PCT No.: PCT/JP2011/050144

§ 371 Date: Sep. 6, 2012

(30) Foreign Application Priority Data
Apr. 20, 2010 (JP) 2010-096969

(51) Int. Cl. G09G 5/10

(52) U.S. Cl. 345/690

(57) ABSTRACT

A liquid crystal display device (1) includes a backlight device (backlight unit) (3) and a liquid crystal panel (display unit) (2) and displays information with one frame period divided into first to third subfield periods. The liquid crystal panel (2) displays information using illumination light from the backlight device (3). In the liquid crystal display device (1), a plurality of illumination areas are set that make light from light emitting diodes (light sources) (11) incident on a plurality of display areas, respectively. A local dimming calculation unit (6) is provided to, in each of the first to third subfield periods, calculate luminance values based on an input image signal on a per illumination area basis and on a per light emitting diode (11) basis, and calculate per-pixel transmittances based on determined luminance values.

### REFERENCE TO RELATED APPLICATIONS

This application is a national stage application under 35 USC 371 of International Application No. PCT/JP2011/050144, filed Jan. 7, 2011, which claims the priority of Japanese Patent Application No. 2010-096969, filed Apr. 20, 2010, the entire contents of which are incorporated herein by reference.

### FIELD OF THE INVENTION

The present invention relates to a display device, and in particular to a nonluminous display device such as a liquid crystal display device.

### BACKGROUND OF THE INVENTION

In recent years, liquid crystal display devices and the like are widely used in, for example, liquid crystal televisions, monitors, and mobile telephones as flat panel displays that are thinner and lighter than conventional displays using cathode ray tubes. Such liquid crystal display devices include a backlight device that emits light and a liquid crystal panel that displays desired images by playing the role of a shutter for light from light sources provided in the backlight device.

The above liquid crystal display devices are known to perform color display using a so-called field sequential driving method. According to this driving method, light emitting diodes (LEDs) of three colors red (R), green (G), and blue (B) are used as light sources for a liquid crystal panel with no color filter, and a red image, a green image, and a blue image can be sequentially displayed in one frame period by sequentially flashing the LEDs of the three colors.

However, with the normal field sequential driving method described above, color display is performed while switching between red, green, and blue images at high speed. This may give rise to a problem called a color breakup phenomenon in which colors of displayed images look split when, for example, video is displayed.

In view of the above, conventional liquid crystal display devices employ a configuration in which a first subfield period, a second subfield period, and a third subfield period are set in one frame period, as described in Patent Document 1 listed below and the like. In the first subfield period, at least the green light emitting diodes emit light out of the red, green, and blue light emitting diodes. In the second subfield period, at least the red light emitting diodes emit light out of the red and blue light emitting diodes. In the third subfield period, the blue light emitting diodes emit light. Furthermore, in each of the first to third subfield periods, these conventional liquid crystal display devices determine a time period in which the light emitting diodes emit light in accordance with an image signal, and generate an image output signal (instruction signal) for the liquid crystal panel in accordance with the determined time period. In this way, these conventional liquid crystal display devices can suppress the color breakup phenomenon.

Patent Document 1: JP 2009-134156A

### SUMMARY OF THE INVENTION

Incidentally, there is demand for a further reduction in power consumption of the above conventional liquid crystal display devices.

However, a problem with the above conventional liquid crystal display devices is that a further reduction in power consumption is difficult to achieve.

In view of the above problem, the present invention aims to provide a display device that can achieve a further reduction in power consumption.

In order to achieve the above aim, a display device of the present invention includes a backlight unit and a display unit and displays information with one frame period divided into N subfield periods (N being an integer greater than or equal to three). The backlight unit has light sources. The display unit has a plurality of pixels and displays information using illumination light from the backlight unit. The display device includes: a plurality of display areas set in the display unit a plurality of illumination areas set in the backlight unit to make light from the light sources incident on the respective display areas; and a control unit that controls driving of the backlight unit and the display unit using an input image signal. Light sources of multiple colors are provided in the backlight unit on a per illumination area basis, the light sources of multiple colors emitting light in multiple colors that can be mixed with white light. The control unit includes a local dimming calculation unit that, in each of the N subfield periods, calculates luminance values based on the input image signal on a per illumination area basis and on a per light source basis, and calculates per-pixel transmittances based on determined luminance values.

In the display device configured in the above manner, the local dimming calculation unit calculates luminance values based on the input image signal on a per illumination area basis and on a per light source basis in each of the N subfield periods. The local dimming calculation unit also calculates per-pixel transmittances based on determined luminance values. In this way, the local dimming calculation unit can appropriately light the light sources on a per illumination area basis based on the input image signal in each subfield period. This allows configuring the display device that can achieve a further reduction in power consumption unlike the conventional example discussed above.

It is preferable that the local dimming calculation unit of the above display device includes: a luminance value determination unit that, in each of the N subfield periods, calculates luminance values of light that is from the illumination areas and incident on the corresponding display areas on a per light source basis based on the input image signal, corrects the calculated luminance values on a per illumination area basis using luminance values for surrounding illumination areas, and determines the corrected luminance values as luminance values of the corresponding light sources; and a transmittance determination unit that, in each of the N subfield periods, determines per-pixel transmittances using luminance values of any of the light sources of multiple colors determined by the luminance value determination unit.

In this way, the luminance value determination unit can appropriately determine the luminance values of light sources on a per illumination area basis in each subfield period while taking into consideration the effects of surrounding illumination areas. Furthermore, the transmittance determination unit can appropriately determine the per-pixel transmittances in accordance with the determined luminance values in each subfield period. It is therefore possible to reliably achieve a further reduction in power consumption.

It is preferable that the luminance value determination unit of the above display device determine the corrected luminance values using data of a predetermined point spread function (PSF) on a per light source basis and on a per illumination area basis.

In this way, information can be displayed on the display unit using more appropriate luminance, and the display quality can be increased accordingly.

In the above display device, first, second, and third subfield periods may be used as the N subfield periods, and red, green, and blue light emitting diodes that respectively emit light in colors red, green, and blue may be used as the light sources of multiple colors. Furthermore, the above display device may be configured as follows. In the first subfield period, the luminance value determination unit determines, on a per illumination area basis, the corrected luminance values of light emitting diodes corresponding to one color among the colors red, green, and blue based on the input image signal; the transmittance determination unit determines per-pixel transmittances for the first subfield period using the determined corrected luminance values of the light emitting diodes corresponding to one color; and the luminance value determination unit determines, on a per illumination area basis, the corrected luminance values of light emitting diodes corresponding to the remaining two colors among the colors red, green, and blue based on the input image signal and the determined per-pixel transmittances for the first subfield period. In the second subfield period, the luminance value determination unit determines, on a per illumination area basis, the corrected luminance values of light emitting diodes corresponding to one of the remaining two colors among the colors red, green, and blue based on the input image signal; the transmittance determination unit determines per-pixel transmittances for the second subfield period using the determined corrected luminance values of the light emitting diodes corresponding to one of the remaining two colors; and the luminance value determination unit determines, on a per illumination area basis, the corrected luminance values of light emitting diodes corresponding to the other of the remaining two colors based on the input image signal and the determined per-pixel transmittances for the second subfield period. In the third subfield period, the luminance value determination unit determines, on a per illumination area basis, the corrected luminance values of the light emitting diodes corresponding to the other of the remaining two colors based on the input image signal; and the transmittance determination unit determines per-pixel transmittances for the third subfield period using the determined corrected luminance values of the light emitting diodes corresponding to the other of the remaining two colors.

In this way, in each subfield period, it is possible to appropriately determine the luminance values of red, green, and blue light included in the light emitted from the illumination areas and incident on the corresponding display areas, as well as the per-pixel transmittances. This allows appropriately using color purity of light of every color, and easily configuring a display device capable of performing color display with excellent display quality.

Furthermore, the above display device is preferably configured as follows. In the first subfield period, the luminance value determination unit determines, on a per illumination area basis, the corrected luminance values of the green light emitting diodes based on the input image signal, and the transmittance determination unit determines the per-pixel transmittances for the first subfield period using the determined corrected luminance values of the green light emitting diodes.

In this way, red and blue can be mixed on the basis of green that has the highest luminosity factor among the colors red, green, and blue. Accordingly, the color breakup phenomenon can be reliably suppressed.

Furthermore, the above display device may be configured as follows. In the second subfield period, the luminance value determination unit determines, on a per illumination area basis, the corrected luminance values of the red light emitting diodes based on the input image signal, and the transmittance determination unit determines the per-pixel transmittances for the second subfield period using the determined corrected luminance values of the red light emitting diodes.

In this way, blue can be mixed on the basis of red that has a relatively higher luminosity factor than blue. Accordingly, the color breakup phenomenon can be suppressed more reliably.

Furthermore, the above display device is preferably configured as follows. In the first subfield period, when determining the corrected luminance values of light emitting diodes corresponding to the remaining two colors among colors red, green, and blue on a per illumination area basis based on the input image signal and determined per-pixel transmittances for the first subfield period, if it is judged that there is an illumination area whose luminance value exceeds the luminance value for a surrounding illumination area by a predetermined value, the luminance value determination unit determines the corrected luminance values after decreasing the luminance value to the predetermined value or less. In the second subfield period, when determining the corrected luminance values of light emitting diodes corresponding to the other of the remaining two colors on a per illumination area basis based on the input image signal and determined per-pixel transmittances for the second subfield period, if it is judged that there is an illumination area whose luminance value exceeds the luminance value for a surrounding illumination area by a predetermined value, the luminance value determination unit determines the corrected luminance values after decreasing the luminance value to the predetermined value or less.

In this way, the luminance values for the illumination areas can be set at more appropriate values that suppress adverse effects on surrounding illumination areas. Accordingly, a decrease in the display quality can be reliably suppressed.

The present invention allows providing a display device that can achieve a further reduction in power consumption.

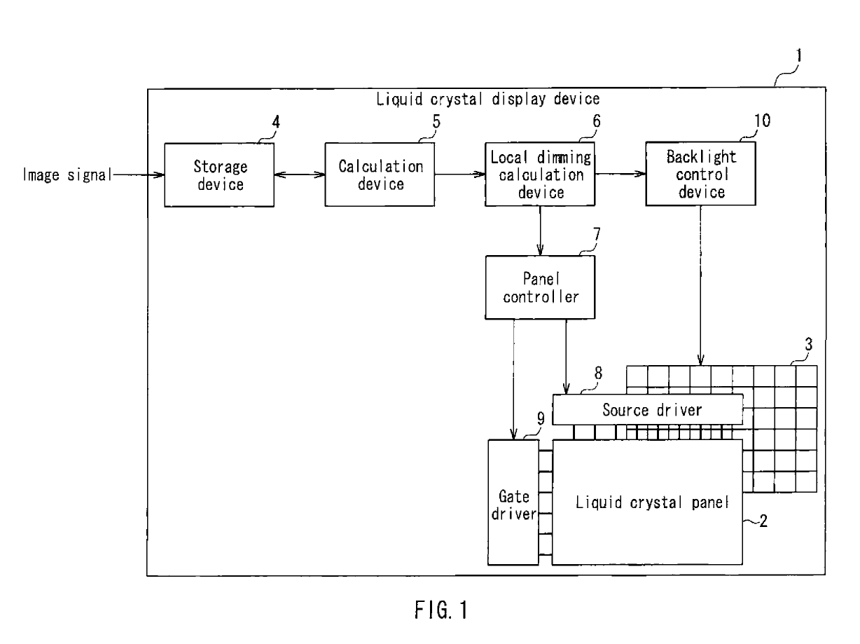

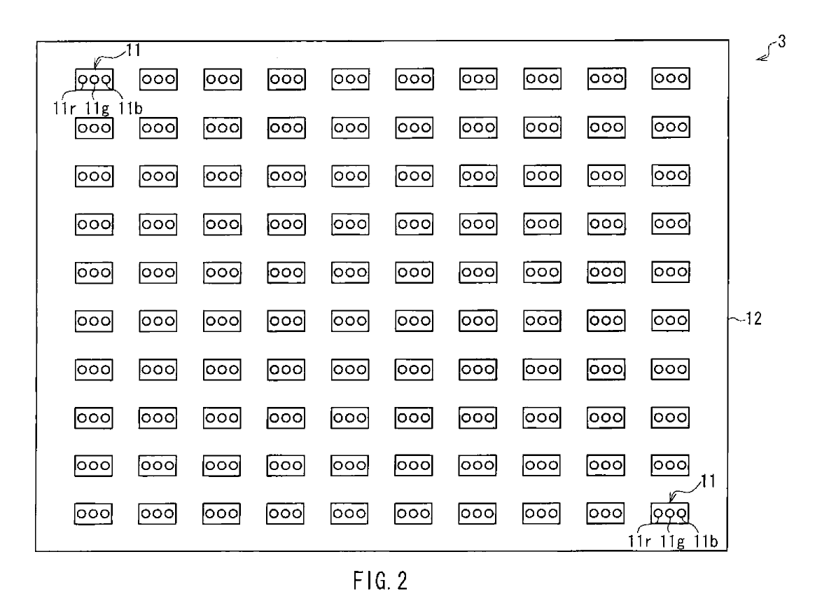

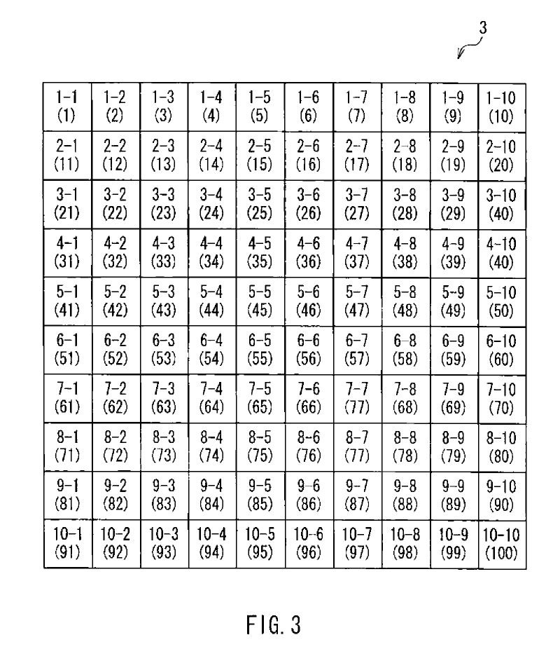

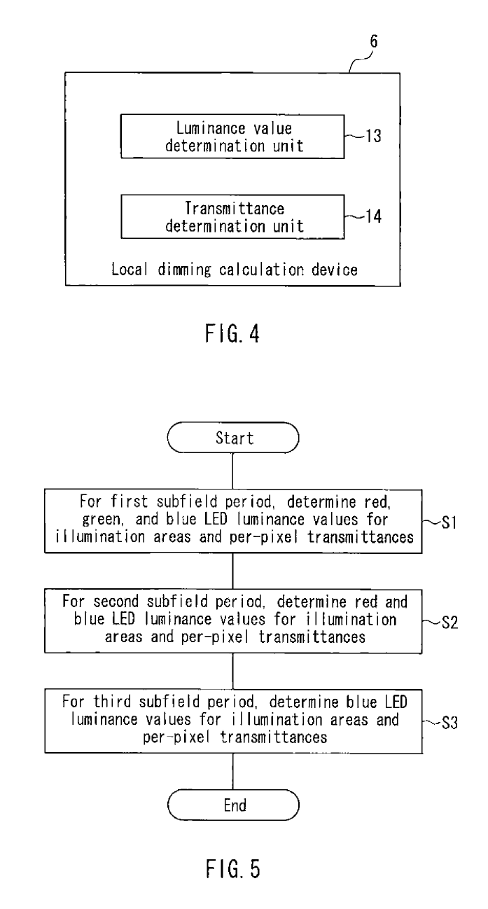

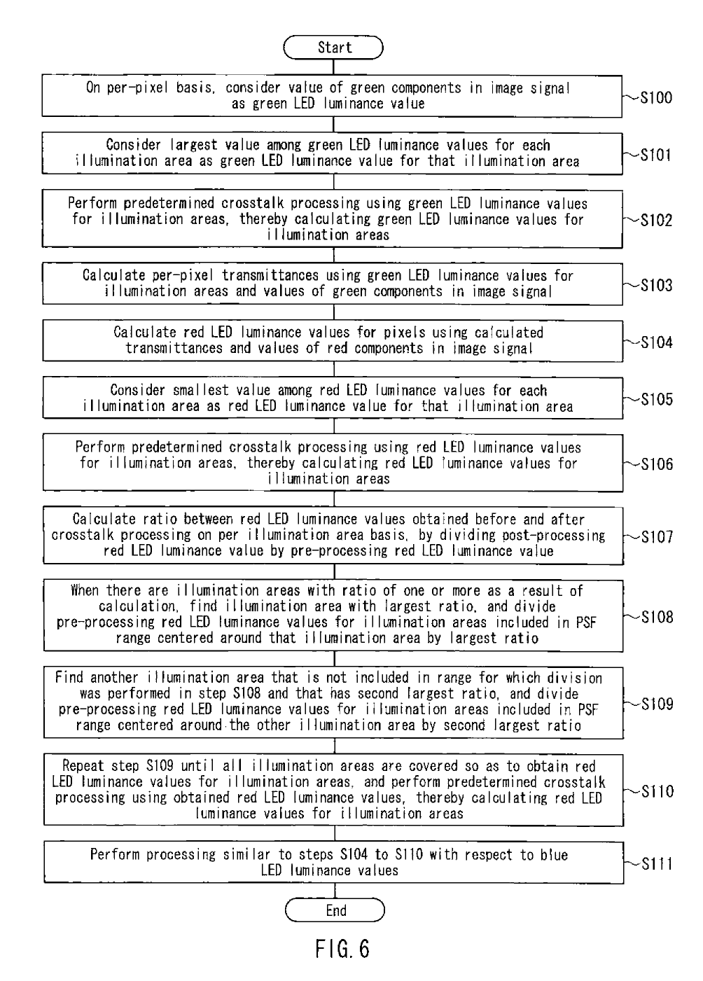

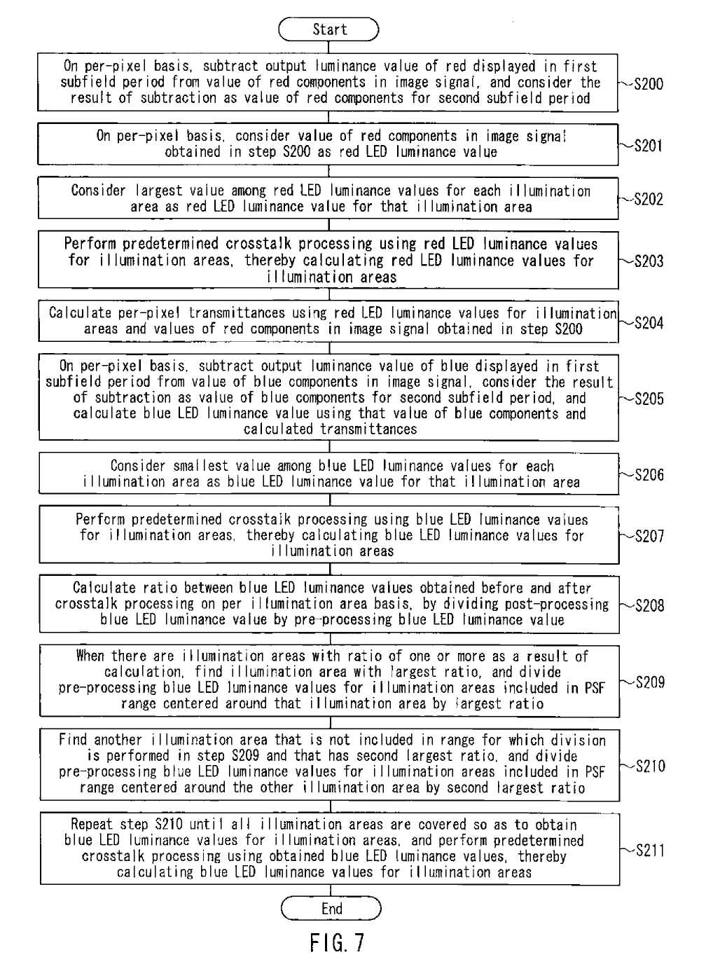

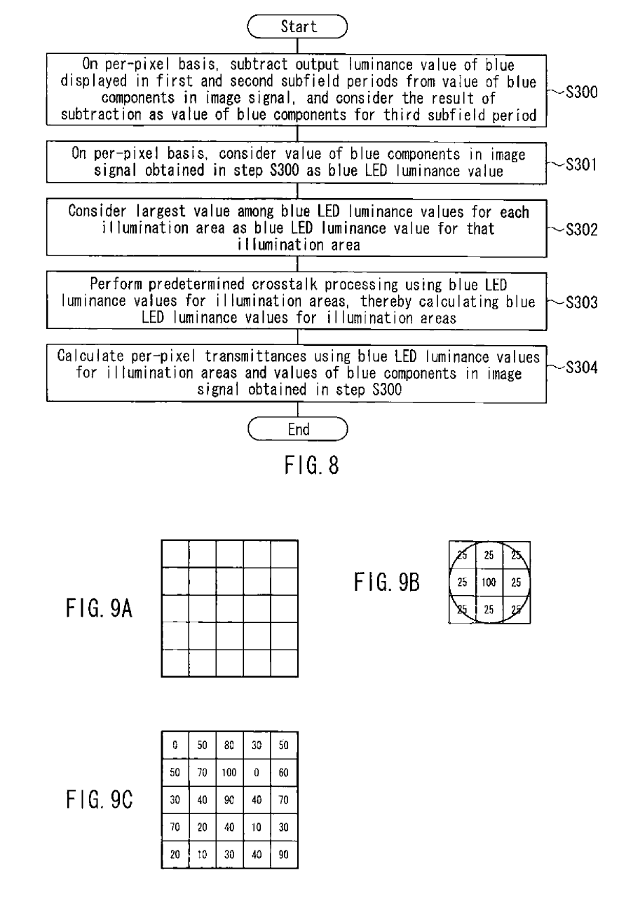

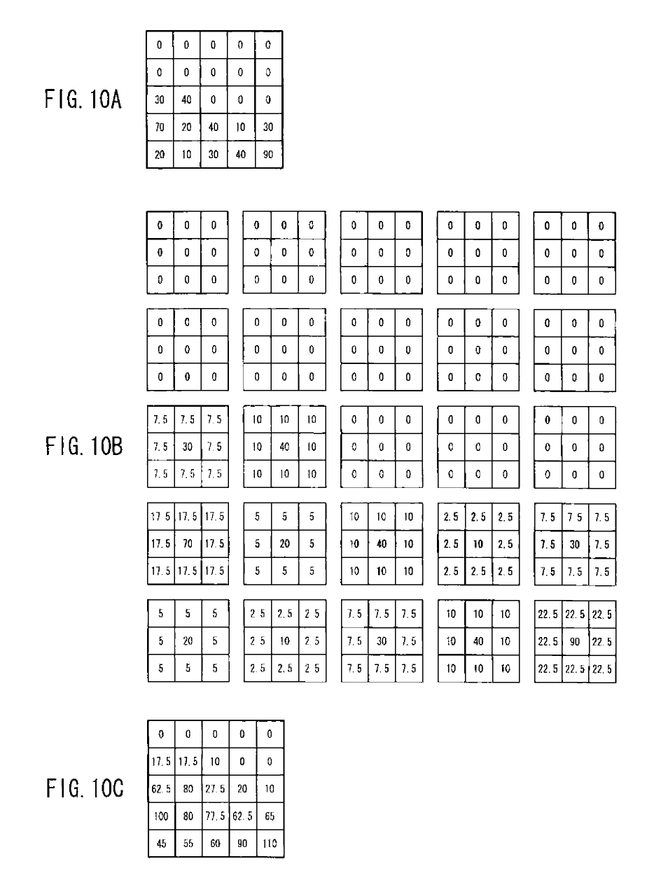

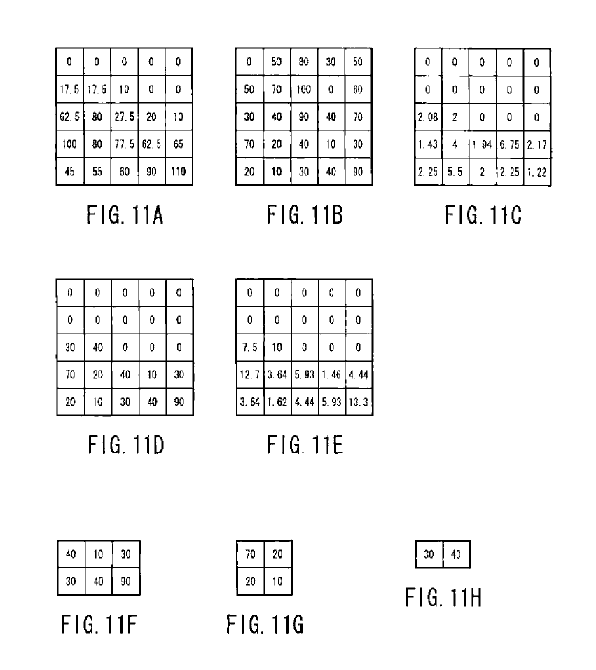

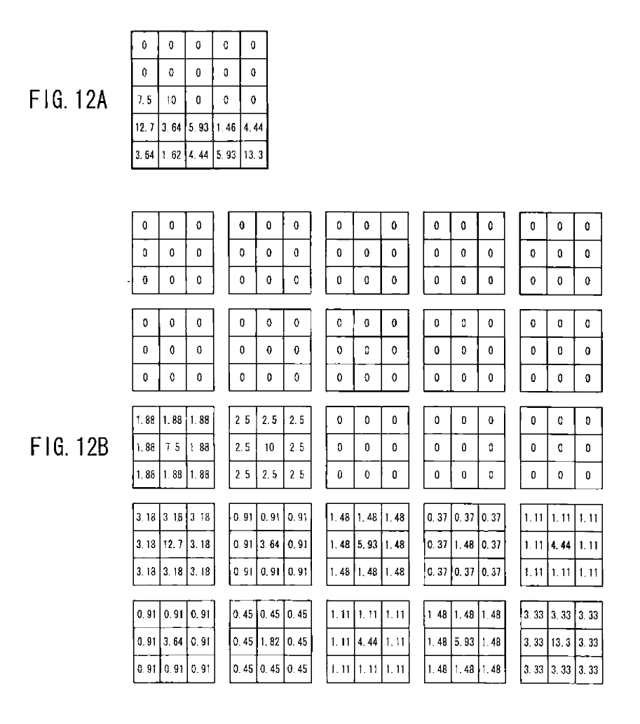

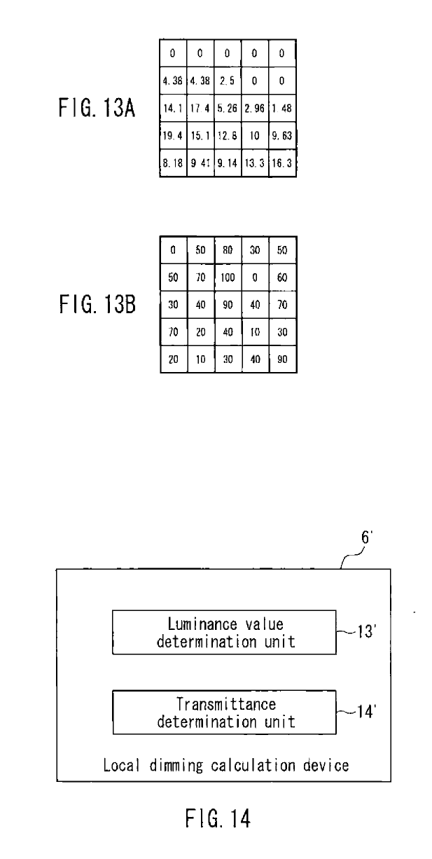

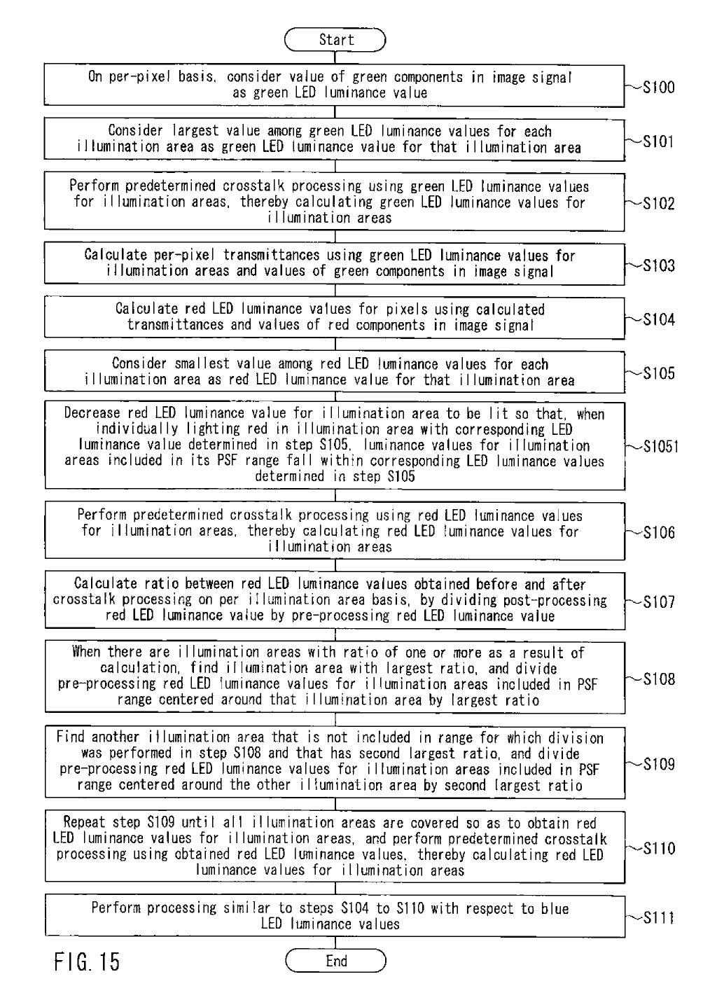

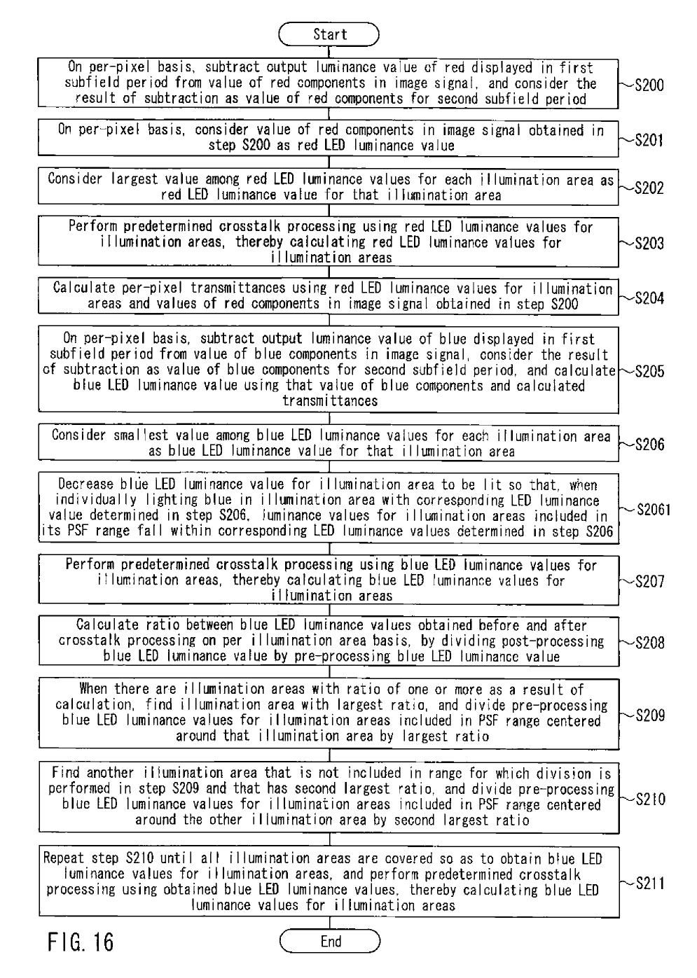

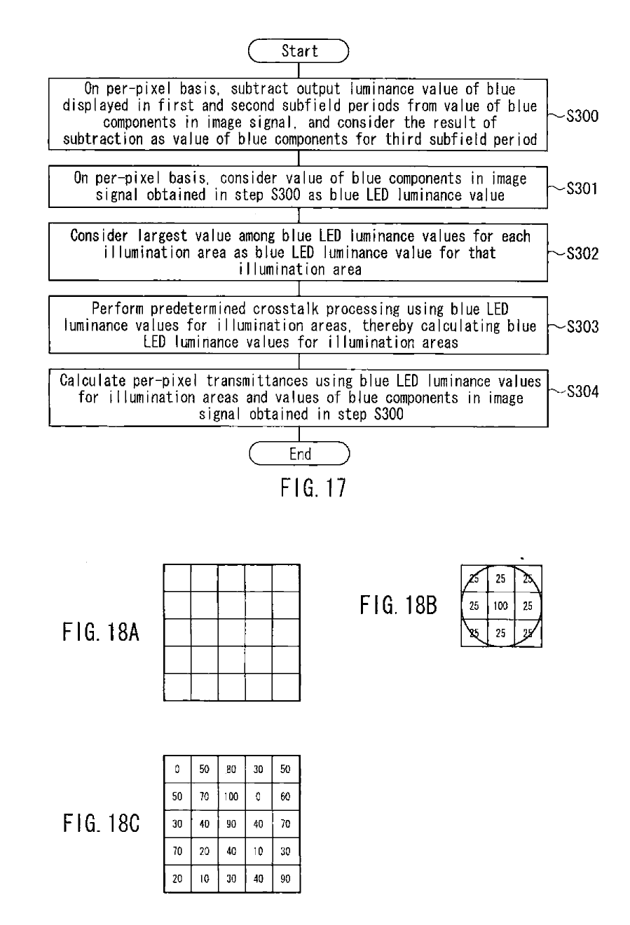

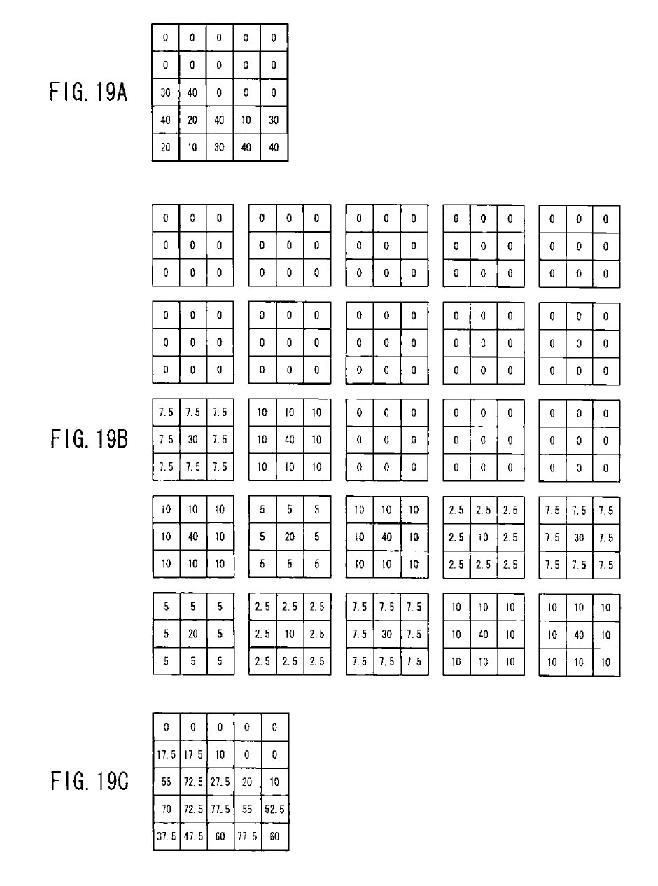

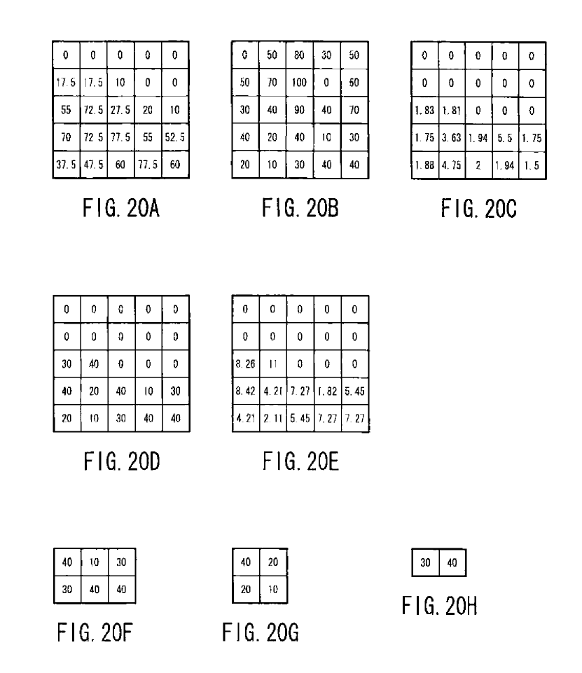

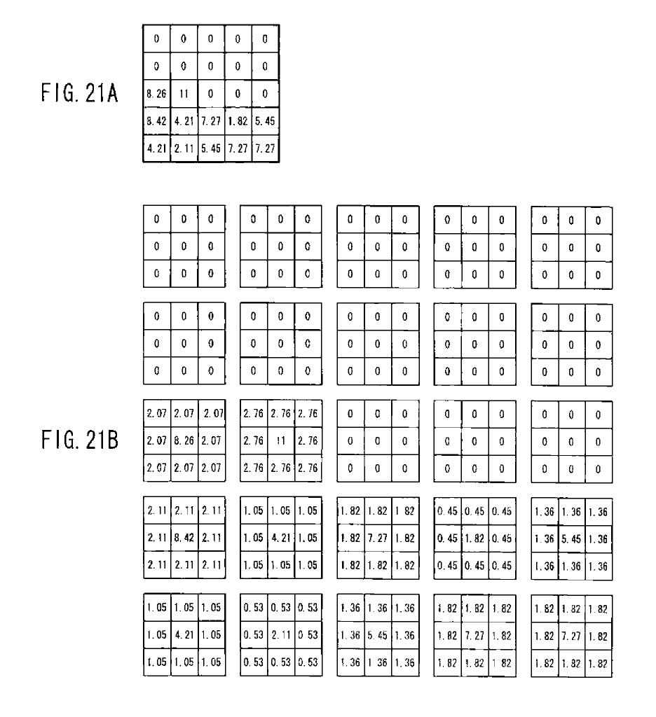

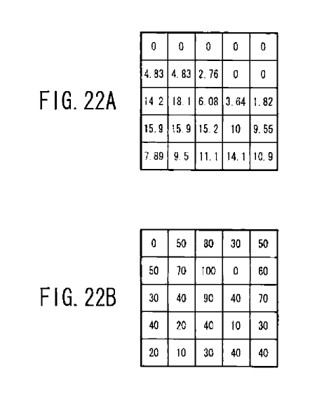

### BRIEF DESCRIPTION OF THE DRAWINGS

[FIG. 1] FIG. 1 shows a main structure of a liquid crystal display device pertaining to First Embodiment of the present invention.

[FIG. 2] FIG. 2 is a plan view showing a main structure of a backlight device shown in FIG. 1.

[FIG. 3] FIG. 3 is a drawing for explaining a specific example of a plurality of illumination areas set in the backlight device and a plurality of display areas toward which light is emitted from the illumination areas.

[FIG. 4] FIG. 4 is a block diagram showing an example of a specific structure of a local dimming calculation device shown in FIG. 1.

[FIG. 5] FIG. 5 is a flowchart of basic operations of the liquid crystal display device shown in FIG. 1.

[FIG. 6] FIG. 6 is a flowchart of specific operations performed in a first subfield period, which are shown in FIG. 5.

[FIG. 7] FIG. 7 is a flowchart of specific operations performed in a second subfield period, which are shown in FIG. 5.

[FIG. 8] FIG. 8 is a flowchart of specific operations performed in a third subfield period, which are shown in FIG. 5.

[FIGS. 9A-9C] FIGS. 9A through 9C are drawings for explaining one example of processing operations of a luminance value determination unit shown in FIG. 4.

[FIGS. 10A-10C] FIGS. 10A through 10C are drawings for explaining one example of processing operations of the luminance value determination unit shown in FIG. 4.

[FIGS. 11A-11H] FIGS. 11A through 11H are drawings for explaining one example of processing operations of the luminance value determination unit shown in FIG. 4.

[FIGS. 12A and 12B] FIGS. 12A and 12B are drawings for explaining one example of processing operations of the luminance value determination unit shown in FIG. 4.

[FIGS. 13A and 13B] FIGS. 13A and 13B are drawings for explaining one example of processing operations of the luminance value determination unit shown in FIG. 4.

[FIG. 14] FIG. 14 is a block diagram showing an example of a specific structure of a local dimming calculation device in a liquid crystal display device pertaining to Second Embodiment of the present invention.

[FIG. 15] FIG. 15 is a flowchart of specific operations performed by the local dimming calculation device shown in FIG. 14 in a first subfield period.

[FIG. 16] FIG. 16 is a flowchart of specific operations performed by the local dimming calculation device shown in FIG. 14 in a second subfield period.

[FIG. 17] FIG. 17 is a flowchart of specific operations performed by the local dimming calculation device shown in FIG. 14 in a third subfield period.

[FIGS. 18A-18C] FIGS. 18A through 18C are drawings for explaining one example of processing operations of the luminance value determination unit shown in FIG. 14.

[FIGS. 19A-19C] FIGS. 19A through 19C are drawings for explaining one example of processing operations of the luminance value determination unit shown in FIG. 14.

[FIGS. 20A-20H] FIGS. 20A through 20H are drawings for explaining one example of processing operations of the luminance value determination unit shown in FIG. 14.

[FIGS. 21A and 21B] FIGS. 21A and 21B are drawings for explaining one example of processing operations of the luminance value determination unit shown in FIG. 14.

[FIGS. 22A and 22B] FIGS. 22A and 22B are drawings for explaining one example of processing operations of the luminance value determination unit shown in FIG. 14.

### DETAILED DESCRIPTION OF THE INVENTION

The following describes preferred embodiments of a display device of the present invention with reference to the drawings. Note that the following description provides an example in which the present invention is applied to a transmissive liquid crystal display device. Also, the dimensions of constituent elements illustrated in the drawings are not precise representations of the actual dimensions or dimensional ratios thereof.

### First Embodiment

FIG. 1 shows a main structure of a liquid crystal display device pertaining to First Embodiment of the present invention. Referring to FIG. 1, a liquid crystal display device 1 of the present embodiment includes a liquid crystal panel 2 and a backlight device 3. The liquid crystal panel 2 serves as a display unit that displays information. The backlight device 3 serves as a backlight unit that emits illumination light toward the liquid crystal panel 2. The liquid crystal panel 2 and the backlight device 3 integrally form the transmissive liquid crystal display device 1.

The liquid crystal display device 1 of the present embodiment also includes a storage device 4 storing an image signal input from the outside, a calculation device 5, and a local dimming calculation device 6. The storage device 4 is connected to the calculation device 5 and the local dimming calculation device 6 in sequence. The local dimming calculation device 6 is connected to a panel controller 7 that controls driving of the liquid crystal panel 2 and to a backlight control device 10 that controls driving of the backlight device 3. The panel controller 7 is connected to a source driver 8 that drives source wiring (not shown in the figures) in the liquid crystal panel 2 and to a gate driver 9 that drives gate wiring (not shown in the figures) in the liquid crystal panel 2.

In the liquid crystal display device 1 of the present embodiment, a plurality of display areas are set in the liquid crystal panel 2, and a plurality of illumination areas are set in the backlight device 3. Furthermore, light emitting diodes (described later) are provided in the backlight device 3 on a per illumination area basis. Light from the light emitting diodes in the illumination areas is incident on the respective display areas. In addition, the liquid crystal display device 1 of the present embodiment is configured to display information with one frame period divided into first, second, and third subfield periods, as will be described later.

Now, a specific description is given of the display areas and the illumination areas with reference to FIGS. 2 and 3.

FIG. 2 is a plan view showing a main structure of the backlight device shown in FIG. 1. FIG. 3 is a drawing for explaining a specific example of the plurality of illumination areas set in the backlight device and the plurality of display areas toward which light is emitted from the illumination areas.

First, the following is a specific description of the backlight device 3 with reference to FIG. 2.

The backlight device 3 includes a plurality of light emitting diodes 11 as light sources and a housing 12 with a closed bottom in which the plurality of light emitting diodes 11 are accommodated. In the backlight device 3, a diffusion plate (not shown in the figures) is arranged to close an opening of the housing 12, and illumination light is emitted in a planar fashion via the diffusion plate toward the liquid crystal panel 2. As illustrated in FIG. 2 as one example, the backlight device 3 uses a total of 100 light emitting diodes 11 arranged in 10 rows and 10 columns respectively parallel to a horizontal direction and a vertical direction of a display surface of the liquid crystal panel 2.

Also, the light emitting diodes 11 are of a so-called 3-in-1 type, that is to say, one light emitting diode 11 is integrally constituted by red, green, and blue light emitting diodes 11r, 11g, and 11b that respectively emit light in colors red (R), green (G), and blue (B). In addition, as will be described later in detail, 100 illumination areas are defined in the backlight device 3 in correspondence with the light emitting diodes 11. The backlight device 3 is configured to make light from the light emitting diodes 11 incident on corresponding 100 display areas, which are set on the display surface in correspondence with these illumination areas. Every illumination area uses the above 3-in-1 light emitting diode 11, and therefore light sources of multiple colors that can be mixed with white light are used in the illumination areas.

Furthermore, in the liquid crystal display device 1, a group of optical sheets (not shown in the figures) such as a polarization sheet and a prism (light-focusing) sheet is disposed between the liquid crystal panel 2 and the diffusion plate. For example, the group of optical sheets increases the luminance of illumination light from the backlight device 3 as appropriate, thereby improving display performance of the liquid crystal panel 2.

As shown in FIG. 3, in the backlight device 3, a total of 100 illumination areas 1-1, 1-2, . . . , 10-9, and 10-10 are set on a light emitting surface that emits illumination light in a planar fashion while facing the liquid crystal panel 2 (a surface of the diffusion plate facing the liquid crystal panel 2). These illumination areas 1-1, 1-2, . . . , 10-9, and 10-10 are set in correspondence with the 100 light emitting diodes 11 arranged in 10 rows and 10 columns as shown in FIG. 2, and one illumination area is located directly above each light emitting diode 11.

Although the illumination areas 1-1, 1-2, . . . , 10-9, and 10-10 are separated from one another by vertical and horizontal lines in FIG. 3 for the sake of clear presentation, the illumination areas 1-1, 1-2, . . . , 10-9, and 10-10 are not actually separated from one another by, for example, borders set on the light emitting surface or partition members arranged in the housing 12. Alternatively, aside from this explanation, it is possible to have a configuration in which the inside of the housing 12 is partitioned by these partition members or the like in accordance with the illumination areas.

The illumination areas 1-1, 1-2, . . . , 10-9, and 10-10 are configured to make light from the light emitting diodes 11 incident on the corresponding 100 display areas (1), (2), . . . , (99), and (100) set on the display surface of the liquid crystal panel 2. Each of these display areas (1), (2), . . . , (99), and (100) has a plurality of pixels (not shown in the figures). More specifically, in the case where the liquid crystal panel 2 has, for example, 1920×1080 pixels in horizontal×vertical directions, each of the display areas (1), (2), . . . , (99), and (100) has 192×108 pixels. As such, in the liquid crystal display device 1, the illumination areas 1-1, 1-2, . . . , 10-9, and 10-10 are set in one-to-one correspondence with the display areas (1), (2), . . . , (99), and (100), and in this way, local dimming (area active backlight) is configured whereby illumination light from one illumination area is incident on one display area as appropriate in accordance with information to be displayed.

According to the above local dimming, in the illumination areas 1-1, 1-2, . . . , 10-9, and 10-10, the light emitting diodes 11r, 11g, and 11b included in the corresponding light emitting diodes 11 can independently emit light of RGB colors toward the liquid crystal panel 2. As a result, in the liquid crystal display device 1, light of RGB colors from the illumination areas 1-1, 1-2, . . . , 10-9, and 10-10 is properly incident on the corresponding display areas (1), (2), . . . , (99), and (100) in accordance with information to be displayed, and therefore reproduction properties for the RGB colors can be easily improved.

Returning to FIG. 1, the storage device 4 is configured to temporarily store an image signal for one frame input from the outside. The calculation device 5 performs predetermined image processing on the image signal stored in the storage device 4. Specifically, the calculation device 5 reads the image signal stored in the storage device 4, and performs the predetermined image processing, such as γ correction, on the read image signal to improve the quality of an output image. Thereafter, the calculation device 5 outputs the image signal that has been subjected to the image processing to the local dimming calculation device 6.

The local dimming calculation device 6 is configured to, in each of the first to third subfield periods, calculate luminance values based on the input image signal on a per illumination area basis and on a per light emitting diode 11 basis, and calculate per-pixel transmittances based on determined luminance values.

Now, a specific description is given of the local dimming calculation device 6 with reference to FIG. 4 as well.

FIG. 4 is a block diagram showing an example of a specific structure of the local dimming calculation device shown in FIG. 1.

As shown in FIG. 4, the local dimming calculation device 6 includes a luminance value determination unit 13 and a transmittance determination unit 14. In each of the first to third subfield periods, the luminance value determination unit 13 calculates the luminance values of light that is emitted from the RGB light emitting diodes 11r, 11g, and 11b in the illumination areas and incident on the corresponding display areas on a per light emitting diode basis, corrects the calculated luminance values on a per illumination area basis using the luminance values for surrounding illumination areas, and determines the corrected luminance values as luminance values (LED luminance values) of the corresponding light emitting diodes 11r, 11g, and 11b (the details are described later).

Note that the luminance value determination unit 13 determines the corrected luminance values of the light emitting diodes 11r, 11g, and 11b using data of a predetermined point spread function (PSF) on a per light emitting diode basis and on a per illumination area basis In other words, the luminance value determination unit 13 is configured to perform predetermined crosstalk processing using PSF data pre-stored in a memory (not shown in the figures), so as to appropriately determine the luminance values of the light emitting diodes 11r, 11g, and 11b on a per illumination area basis while taking into consideration the effects of surrounding illumination areas.

The PSF data may also be referred to as luminance distribution data, and is a numeric value obtained by measuring or calculating the spreading of light from the light emitting diodes (light sources) 11r, 11g, and 11b as visible on the liquid crystal panel 2 including the group of optical sheets and the like. As has been mentioned earlier, the PSF data is pre-stored in a memory. By using the PSF data, information can be displayed on the liquid crystal panel (display unit) 2 using more appropriate luminance, and thus the display quality can be increased.

As will be described later in detail, the transmittance determination unit 14 is configured to, in each of the first to third subfield periods, determine the per-pixel transmittances using the luminance values of any of the light emitting diodes 11r, 11g, and 11b determined by the luminance value determination unit 13.

Returning to FIG. 1, the local dimming calculation device 6 outputs, to the panel controller 7, the image signal including the per-pixel transmittances determined by the transmittance determination unit 14. The local dimming calculation device 6 also outputs, to the backlight control device 10, a backlight control signal including the luminance values of the light emitting diodes 11r, 11g, and 11b determined by the luminance value determination unit 13.

In accordance with the image signal from the local dimming calculation device 6, the panel controller 7 outputs a control signal to the source driver 8 and the gate driver 9. Based on the control signal from the panel controller 7, the source driver 8 and the gate driver 9 drive the liquid crystal panel 2 in units of pixels. Consequently, a display operation (shutter operation) is performed with respect to the pixels of the liquid crystal panel 2 in accordance with the transmittances determined by the transmittance determination unit 14.

The backlight control device 10 generates a lighting instruction signal for lighting the light emitting diodes 11r, 11g, and 11b based on the backlight control signal from the local dimming calculation device 6, and outputs the generated lighting instruction signal. As a result, a lighting operation is performed by the light emitting diodes 11r, 11g, and 11b of the backlight device 3 in accordance with the luminance values determined by the luminance value determination unit 13.

Note that the calculation device 5, the local dimming calculation device 6, the panel controller 7, and the backlight control device 10 constitute a control unit that controls driving of the liquid crystal panel 2 and the backlight device 3 using the input image signal.

The following is a specific description of operations of the liquid crystal display device 1 pertaining to the present embodiment configured in the above manner, with reference to FIGS. 5 through 8. It should be noted that operations of the local dimming calculation device 6 are mainly discussed in the following description.

FIG. 5 is a flowchart of basic operations of the liquid crystal display device shown in FIG. 1. FIG. 6 is a flowchart of specific operations performed in the first subfield period, which are shown in FIG. 5. FIG. 7 is a flowchart of specific operations performed in the second subfield period, which are shown in FIG. 5. FIG. 8 is a flowchart of specific operations performed in the third subfield period, which are shown in FIG. 5.

As shown in step S1 of FIG. 5, the luminance value determination unit 13 in the local dimming calculation device 6 of the present embodiment determines the LED luminance values of the light emitting diodes 11r, 11g, and 11b in the illumination areas for the first subfield period. Also, the transmittance determination unit 14 determines the per-pixel transmittances for the first subfield period.

Next, as shown in step S2 of FIG. 5, the luminance value determination unit 13 in the local dimming calculation device 6 of the present embodiment determines the LED luminance values of the light emitting diodes 11r and 11b in the illumination areas for the second subfield period. Also, the transmittance determination unit 14 determines the per-pixel transmittances for the second subfield period.

Lastly, as shown in step S3 of FIG. 5, the luminance value determination unit 13 in the local dimming calculation device 6 of the present embodiment determines the LED luminance values of the light emitting diodes 11b in the illumination areas for the third subfield period. Also, the transmittance determination unit 14 determines the per-pixel transmittances for the third subfield period.

To be more specific, in the above step S1, processing operations shown in FIG. 6 are performed in sequence.

That is, as processing operations in the first subfield period, the luminance value determination unit 13 first considers values of green (G) components in the pixels, which are included in the image signal for one frame stored in the storage device 4, as green LED luminance values (i.e. the luminance values of the light emitting diodes 11g) as shown in step S100 of FIG. 6.

Next, the luminance value determination unit 13 considers the largest value among the green LED luminance values for each illumination area as the green LED luminance value for that illumination area (step S101).

Subsequently, the luminance value determination unit 13 performs predetermined crosstalk processing using the green LED luminance values for the illumination areas, thereby calculating the green LED luminance values for the illumination areas (step S102). As has been mentioned above, the crosstalk processing utilizes the PSF data, and by executing this step S102, the corrected luminance values of the green light emitting diodes 11g in the illumination areas are determined for the first subfield period.

Thereafter, the transmittance determination unit 14 calculates the per-pixel transmittances using the LED luminance values of the green light emitting diodes 11g in the illumination areas, which were determined by the luminance value determination unit 13, and the values of green (G) components in the pixels included in the image signal (step S103). Specifically, the transmittance determination unit 14 determines the per-pixel transmittances by dividing the values of green (G) components in the pixels by the LED luminance values of the green light emitting diodes 11g in the corresponding illumination areas.

Following that, the luminance value determination unit 13 calculates red LED luminance values for the pixels (i.e. luminance values of the light emitting diodes 11r) using the transmittances determined by the transmittance determination unit 14 and values of red (R) components in the pixels included in the image signal (step S104).

Then, the luminance value determination unit 13 considers the smallest value among the red LED luminance values for each illumination area as the red LED luminance value for that illumination area (step S105).

Subsequently, the luminance value determination unit 13 performs predetermined crosstalk processing using the red LED luminance values for the illumination areas, thereby calculating the red LED luminance values for the illumination areas (step S106).

Thereafter, the luminance value determination unit 13 calculates a ratio between red LED luminance values obtained before and after the crosstalk processing on a per illumination area basis, by dividing the red LED luminance value obtained after the crosstalk processing (hereinafter, “post-processing”) by the red LED luminance value obtained before the crosstalk processing (hereinafter, “pre-processing”) (step S107).

Next, when there are illumination areas that have a ratio of one or more as a result of the calculation in step S107, the luminance value determination unit 13 finds an illumination area with the largest ratio, and divides the pre-processing red LED luminance values for illumination areas included in a PSF range centered around that illumination area by the largest ratio (step S108).

The luminance value determination unit 13 then finds another illumination area that is not included in the range for which the division is performed in step S108 and that has the second largest ratio, and divides the pre-processing red LED luminance values for illumination areas included in a PSF range centered around the other illumination area by the second largest ratio (step S109).

The luminance value determination unit 13 repeats the above step S109 until all the illumination areas are covered so as to obtain the red LED luminance values for the illumination areas. Furthermore, the luminance value determination unit 13 performs predetermined crosstalk processing using the obtained red LED luminance values, thereby calculating the red LED luminance values for the illumination areas (step S110). In this way, the corrected luminance values of the red light emitting diodes 11r in the illumination areas are determined for the first subfield period.

Thereafter, the luminance value determination unit 13 performs processing similar to steps 5104 through S110 with respect to the blue LED luminance values (step S111). In this way, the corrected luminance values of the blue light emitting diodes 11b in the illumination areas are determined for the first subfield period.

By performing the processing operations of steps S106 through S110 and step S111, the liquid crystal display device 1 of the present embodiment can mix red and blue on the basis of green that has the highest luminosity factor in the first subfield period, while taking into consideration the effects of surrounding illumination areas. As a result, the liquid crystal display device 1 of the present embodiment can appropriately display the colors red, green, and blue without losing coloration of the input image signal.

Now, a specific description is given of the processing operations of steps S106 through S110 with reference to FIGS. 9A through 13B.

FIGS. 9A through 9C are drawings for explaining one example of processing operations of the luminance value determination unit shown in FIG. 4. FIGS. 10A through 10C are drawings for explaining one example of processing operations of the luminance value determination unit shown in FIG. 4. FIGS. 11A through 11H are drawings for explaining one example of processing operations of the luminance value determination unit shown in FIG. 4. FIGS. 12A and 12B are drawings for explaining one example of processing operations of the luminance value determination unit shown in FIG. 4. FIGS. 13A and 13B are drawings for explaining one example of processing operations of the luminance value determination unit shown in FIG. 4.

The following describes processing operations for a total of 25 illumination areas arranged in 5 rows and 5 columns, as shown in FIG. 9A as one example. Furthermore, in the following description, data shown in FIG. 9B is used as the PSF data. That is, as indicated by the 3×3 matrix of FIG. 9B, provided that the LED luminance value for the central illumination area targeted for the crosstalk processing is 100%, the luminance of 8 illumination areas surrounding the central illumination area is increased by 25% (according to the PSF data) of the LED luminance value for the central illumination area.

In addition, the following description provides an example in which the luminance value determination unit 13 has determined the red LED luminance values for the 25 illumination areas shown in FIG. 9A by the time the processing operation of step S105 is completed. The determined red LED luminance values are shown in FIG. 9C.

When the red LED luminance values for the 25 illumination areas have been determined as shown in FIG. 9C, in the crosstalk processing of step S106, the LED luminance values for illumination areas surrounding an illumination area with an LED luminance value of “0” are also “0” according to the PSF data (i.e. the corresponding light emitting diodes 11r are not lit). Therefore, in the crosstalk processing of step S106, the luminance value determination unit 13 executes the crosstalk processing after converting the LED luminance values for the 25 illumination areas shown in FIG. 9C into the LED luminance values shown in FIG. 10A according to the PSF data.

To be more specific, calculation is performed on the LED luminance value for each of the 25 illumination areas shown in FIG. 10A based on the PSF data shown in FIG. 9B, so as to obtain the LED luminance values for 8 surrounding illumination areas as shown in FIG. 10B. Then, the crosstalk processing is performed using the LED luminance values shown in FIG. 10B, and the red LED luminance values for the 25 illumination areas are determined as shown in FIG. 10C.

Specifically, as one example, the LED luminance value “17.5” for an illumination area at the second row from the top and the first column from the left in FIG. 10C is calculated by adding the following LED luminance values: the central LED luminance value “0” of a matrix that is the second from the top and the first from the left in FIG. 10B, namely the LED luminance value “0” for this illumination area; the LED luminance value “0” for an illumination area immediately below the central LED luminance value “0” of a matrix that is the first from the top and the first from the left in FIG. 10B; the LED luminance value “7.5” for an illumination area immediately above the central LED luminance value “30” of a matrix that is the third from the top and the first from the left in FIG. 10B; the LED luminance value “0” for an illumination area located diagonally to the lower-left of the central LED luminance value “0” of a matrix that is the first from the top and the second from the left in FIG. 10B; the LED luminance value “0” for an illumination area located to the left of the central LED luminance value “0” of a matrix that is the second from the top and the second from the left in FIG. 10B; and the LED luminance value “10” for an illumination area located diagonally to the upper-left of the central LED luminance value “40” of a matrix that is the third from the top and the second from the left in FIG. 10B.

As another example, the LED luminance value “80” for an illumination area at the third row from the top and the second column from the left in FIG. 10C is calculated by adding the following LED luminance values: the central LED luminance value “40” of a matrix that is the third from the top and the second from the left in FIG. 10B, namely the LED luminance value “40” for this illumination area: the LED luminance value “0” for an illumination area located diagonally to the lower-right of the central LED luminance value “0” of a matrix that is the second from the top and the first from the left in FIG. 10B; the LED luminance value “7.5” for an illumination area located to the right of the central LED luminance value “30” of a matrix that is the third from the top and the first from the left in FIG. 10B; the LED luminance value “17.5” for an illumination area located diagonally to the upper-right of the central LED luminance value “70” of a matrix that is the fourth from the top and the first from the left in FIG. 10B; the LED luminance value “0” for an illumination area immediately below the central LED luminance value “0” of a matrix that is the second from the top and the second from the left in FIG. 10B; the LED luminance value “5” for an illumination area immediately above the central LED luminance value “20” of a matrix that is the fourth from the top and the second from the left in FIG. 10B; the LED luminance value “0” for an illumination area located diagonally to the lower-left of the central LED luminance value “0” of a matrix that is the second from the top and the third from the left in FIG. 10B; the LED luminance value “0” for an illumination area located to the left of the central LED luminance value “0” of a matrix that is the third from the top and the third from the left in FIG. 10B; and the LED luminance value “10” for an illumination area located diagonally to the upper-left of the central LED luminance value “40” of a matrix that is the fourth from the top and the third from the left in FIG. 10B.

Thereafter, the luminance value determination unit 13 performs the processing operation of step S107. That is, the luminance value determination unit 13 calculates ratios between red LED luminance values obtained before and after the crosstalk processing, by dividing the post-processing red LED luminance values shown in FIG. 11A by the pre-processing red LED luminance values shown in FIG. 11B. Note that in this calculation processing, the LED luminance values for illumination areas surrounding an illumination area with an LED luminance value of “0” are also “0” according to the PSF data, as shown in FIG. 10A. The result of processing in step S107 is the data shown in FIG. 11C.

Subsequently, the luminance value determination unit 13 performs the processing operation of step S108. That is, the luminance value determination unit 13 judges whether or not the data shown in FIG. 11C includes illumination areas with a ratio of one or more. When judging that there are illumination areas with a ratio of one or more, the luminance value determination unit 13 finds an illumination area with the largest ratio, and divides the pre-processing red LED luminance values for illumination areas included in a PSF range centered around that illumination area by the largest ratio.

To be more specific, once the luminance value determination unit 13 finds an illumination area with the largest ratio “6.75” from the data shown in FIG. 11C, it extracts, from the pre-processing red LED luminance values shown in FIG. 11D, the pre-processing red LED luminance values for illumination areas included in the PSF range centered around that illumination area with the largest ratio. That is, the luminance value determination unit 13 obtains the LED luminance values for the illumination areas included in the PSF range that are to be divided by the largest ratio “6.75” as shown in FIG. 11F, and performs the division using the largest ratio “6.75”. As a result of the division, the following LED luminance values are obtained: the LED luminance value “5.93” at the fourth row from the top and the third column from the left in FIG. 11E (=40/6.75); the LED luminance value “1.46” at the fourth row from the top and the fourth column from the left in FIG. 11E (32 10/6.75); the LED luminance value“4.44” at the fourth row from the top and the fifth column from the left in FIG. 11E (=30/6.75); the LED luminance value“4.44” at the fifth row from the top and the third column from the left in FIG. 11E (=30/6.75); the LED luminance value “5.93” at the fifth row from the top and the fourth column from the left in FIG. 11E (=40/6.75); and the LED luminance value “13.3” at the fifth row from the top and the fifth column from the left in FIG. 11E (=90/6.75).

Thereafter, the luminance value determination unit 13 performs the processing operation of step S109. That is, the luminance value determination unit 13 finds an illumination area that is not included in the range for which the division is performed in step 5108 and that has the second largest ratio, and divides the pre-processing red LED luminance values for illumination areas included in a PSF range centered around that illumination area by the second largest ratio.

To be more specific, once the luminance value determination unit 13 finds an illumination area with the second largest ratio “5.5” from the data shown in FIG. 11C, it extracts, from the pre-processing red LED luminance values shown in FIG. 11D, the pre-processing red LED luminance values for illumination areas included in the PSF range centered around that illumination area with the second largest ratio. That is, the luminance value determination unit 13 obtains the LED luminance values for the illumination areas included in the PSF range that are to be divided by the second largest ratio “5.5” as shown in FIG. 11G, and performs the division using the second largest ratio “5.5”. As a result of the division, the following LED luminance values are obtained: the LED luminance value “12.7” at the fourth row from the top and the first column from the left in FIG. 11E (=70/5.5); the LED luminance value “3.64” at the fourth row from the top and the second column from the left in FIG. 11E (=20/5.5); the LED luminance value “3.64” at the fifth row from the top and the first column from the left in FIG. 11E (=20/5.5); and the LED luminance value “1.62” at the fifth row from the top and the second column from the left in FIG. 11E (=10/5.5).

Following that, the luminance value determination unit 13 performs the processing operation of step S110. That is, the luminance value determination unit 13 finds an illumination area that is not included in the ranges for which the division is performed in steps S108 and S109 and that has the third largest ratio, and divides the pre-processing red LED luminance values for illumination areas included in a PSF range centered around that illumination area by the third largest ratio.

To be more specific, once the luminance value determination unit 13 finds an illumination area with the third largest ratio “4” from the data shown in FIG. 11C, it extracts, from the pre-processing red LED luminance values shown in FIG. 11D, the pre-processing red LED luminance values for the illumination areas included in the PSF range centered around that illumination area with the third largest ratio. That is, the luminance value determination unit 13 obtains the LED luminance values for the illumination areas included in the PSF range that are to be divided by the third largest ratio “4” as shown in FIG. 11H, and performs the division using the third largest ratio “4”. As a result, the following LED luminance values are obtained: the LED luminance value “7.5” at the third row from the top and the first column from the left in FIG. 11E (=30/4); and the LED luminance value “10” at the third row from the top and the second column from the left in FIG. 11E (=40/4).

Thereafter, once the luminance value determination unit 13 judges that step S109 has been repeated until all the illumination areas are covered, it performs predetermined crosstalk processing using the red LED luminance values for the illumination areas at that point, thereby calculating the red LED luminance values for the illumination areas.

To be more specific, calculation is performed on the LED luminance value for each of the 25 illumination areas shown in FIG. 12A based on the PSF data shown in FIG. 9B, so as to obtain the LED luminance values for 8 surrounding illumination areas as shown in FIG. 12B. Then, the crosstalk processing is performed using the LED luminance values shown in FIG. 12B as in step S106, and the red LED luminance values for the 25 illumination areas are determined as shown in FIG. 13A. That is, the luminance value determination unit 13 considers the data shown in FIG. 13A as the corrected luminance values of the red light emitting diodes 11r in the illumination areas for the first subfield period.

Note that the red LED luminance values for the 25 illumination areas shown in FIG. 13A do not exceed the corresponding red LED luminance values for the 25 illumination areas shown in FIG. 13B, which were determined in step 5105. In this way, the liquid crystal display device 1 of the present embodiment can appropriately display the color red in accordance with the input image signal. Specifically, the liquid crystal display device 1 of the present embodiment calculates ratios between the red LED luminance values obtained before and after the crosstalk processing, and finds illumination areas with a ratio of one or more (i.e. illumination areas whose luminance is prominent compared to surrounding illumination areas). When the illumination areas with a ratio of one or more are found, the luminance values for illumination areas included in the above-described PSF ranges are divided by the ratios of these illumination areas. Consequently, images can be displayed without damaging the color red (the same goes for display of the color blue in the first and second subfield periods).

In step S2, processing operations shown in FIG. 7 are performed in sequence.

Specifically, as processing operations in the second subfield period, the luminance value determination unit 13 first performs the following operations on a per-pixel basis as shown in step S200 of FIG. 7: subtracting the output luminance value of the color red displayed in the first subfield period from a value of red (R) components in the image signal; and considering the result of the subtraction as a value of red components for the second subfield period. Here, the output luminance value is obtained by multiplying the transmittance by the LED luminance value pertaining to the first subfield period, and denotes a display luminance value with which actual display is performed with respect to each pixel in the first subfield period.

Following that, on a per-pixel basis, the luminance value determination unit 13 considers the value of red components in the image signal, which was obtained in step S200, as the red LED luminance value (i.e. the luminance value of the light emitting diode 11r) (step S201).

Next, the luminance value determination unit 13 considers the largest value among the red LED luminance values for each illumination area as the red LED luminance value for that illumination area (step S202).

Subsequently, the luminance value determination unit 13 performs predetermined crosstalk processing using the red LED luminance values for the illumination areas, thereby calculating the red LED luminance values for the illumination areas (step S203). As has been mentioned above, the crosstalk processing utilizes the PSF data, and by executing this step S203, the corrected luminance values of the red light emitting diodes 11r in the illumination areas are determined for the second subfield period.

Thereafter, the transmittance determination unit 14 calculates per-pixel transmittances using the LED luminance values of the red light emitting diodes 11r in the illumination areas, which were determined by the luminance value determination unit 13, and the values of red (R) components in the pixels included in the image signal, which were obtained in step S200 (step S204). Specifically, the transmittance determination unit 14 determines the per-pixel transmittances by dividing the values of red (R) components in the pixels by the LED luminance values of the red light emitting diodes 11r in the corresponding illumination areas.

Subsequently, the luminance value determination unit 13 performs the following operations on a per-pixel basis: subtracting the output luminance value of the color blue displayed in the first subfield period from the value of blue (B) components in the image signal; and considering the result of the subtraction as a value of blue components for the second subfield period. Furthermore, the luminance value determination unit 13 calculates the blue LED luminance values for the pixels using the values of blue components and the transmittances determined by the transmittance determination unit 14 (step S205).

Next, the luminance value determination unit 13 considers the smallest value among the blue LED luminance values for each illumination area as the blue LED luminance value for that illumination area (step S206).

Subsequently, the luminance value determination unit 13 performs predetermined crosstalk processing using the blue LED luminance values for the illumination areas, thereby calculating the blue LED luminance values for the illumination areas (step S207).

The luminance value determination unit 13 then calculates a ratio between blue LED luminance values obtained before and after the crosstalk processing on a per illumination area basis, by dividing the post-processing blue LED luminance value by the pre-processing blue LED luminance value (step S208).

When there are illumination areas that have a ratio of one or more as a result of the calculation in step S208, the luminance value determination unit 13 finds an illumination area with the largest ratio, and divides the pre-processing blue LED luminance values for illumination areas included in a PSF range centered around that illumination area by the largest ratio (step S209).

The luminance value determination unit 13 then finds another illumination area that is not included in the range for which the division was performed in step S209 and that has the second largest ratio, and divides the pre-processing blue LED luminance values for illumination areas included in a PSF range centered around the other illumination area by the second largest ratio (step S210).

The luminance value determination unit 13 repeats the above step S210 until all the illumination areas are covered so as to obtain the blue LED luminance values for the illumination areas. Furthermore, the luminance value determination unit 13 performs predetermined crosstalk processing using the obtained blue LED luminance values, thereby calculating the blue LED luminance values for the illumination areas (step S211). In this way, the corrected luminance values of the blue light emitting diodes 11b in the illumination areas are determined for the second subfield period.

In step S3, processing operations shown in FIG. 8 are performed in sequence.

More specifically, as processing operations in the third subfield period, the luminance value determination unit 13 first performs the following operations on a per-pixel basis as shown in step S300 of FIG. 8: subtracting the output luminance values of the color blue displayed in the first and second subfield periods from a value of blue (B) components in the image signal; and considering the result of the subtraction as a value of blue components for the third subfield period.

Next, on a per-pixel basis, the luminance value determination unit 13 considers the value of blue components in the image signal, which was obtained in step S300, as the blue LED luminance value (i.e. the luminance value of the light emitting diode 11b) (step S301).

Following that, the luminance value determination unit 13 considers the largest value among the blue LED luminance values for each illumination area as the blue LED luminance value for that illumination area (step S302).

The luminance value determination unit 13 then performs predetermined crosstalk processing using the blue LED luminance values for the illumination areas, thereby calculating the blue LED luminance values for the illumination areas (step S303). As has been mentioned above, the crosstalk processing utilizes the PSF data, and by executing this step S303, the corrected luminance values of the blue light emitting diodes 11b in the illumination areas are determined for the third subfield period.

Thereafter, the transmittance determination unit 14 calculates per-pixel transmittances using the LED luminance values of the blue light emitting diodes 11b in the illumination areas, which were determined by the luminance value determination unit 13, and the values of blue (B) components in the pixels included in the image signal, which were obtained in step S300 (step S304). That is, the transmittance determination unit 14 determines the per-pixel transmittances by dividing the values of blue (B) components in the pixels by the LED luminance values of the blue light emitting diodes 11b in the corresponding illumination areas.

In the liquid crystal display device 1 of the present embodiment having the above configuration, the local dimming calculation unit 6 calculates, in each of the first to third subfield periods, the luminance values of the light emitting diodes 11r, 11g, and 11b based on the input image signal on a per illumination area basis and on a per light emitting diode (light source) basis. The local dimming calculation unit 6 also calculates the per-pixel transmittances based on the determined luminance values. In this way, the local dimming calculation unit 6 can appropriately light the light emitting diodes 11r, 11g, and 11b on a per illumination area basis based on the input image signal in each subfield period. Hence, the present embodiment allows configuring the liquid crystal display device 1 that can achieve a further reduction in power consumption unlike the conventional example discussed above.

That is, during the first subfield period, the liquid crystal display device 1 of the present embodiment can mix red and blue on the basis of green that has the highest luminosity factor among the three colors red, green, and blue, thus reliably suppressing the color breakup phenomenon. Furthermore, during the second subfield period, blue can be mixed on the basis of red that has a relatively higher luminosity factor than blue. As a result, the color breakup phenomenon can be suppressed more reliably. The liquid crystal display device 1 of the present embodiment can also determine whether or not the light emitting diodes 11r, 11g, and 11b need to be lit on a per illumination area basis, because it determines the luminance values of the light emitting diodes 11r, 11g, and 11b on a per illumination area basis. Consequently, the liquid crystal display device 1 of the present embodiment can suppress the color breakup phenomenon and achieve a further reduction in power consumption unlike the conventional example discussed above.

In addition, as the local dimming calculation unit 6 of the present embodiment includes the luminance value determination unit 13, it is possible to appropriately determine the luminance values of the light emitting diodes 11r, 11g, and 11b on a per illumination area basis in each subfield period while taking into consideration the effects of surrounding illumination areas. Moreover, as the local dimming calculation unit 6 also includes the transmittance determination unit 14, it is possible to appropriately determine the per-pixel transmittances in accordance with the determined luminance values in each subfield period. Consequently, the liquid crystal display device 1 of the present embodiment can reliably achieve a further reduction in power consumption.

### Second Embodiment

FIG. 14 is a block diagram showing an example of a specific structure of a local dimming calculation device in a liquid crystal display device pertaining to Second Embodiment of the present invention. As can be seen from the drawings, the present embodiment mainly differs from First Embodiment explained above in the following point. In each of the first and second subfields, when determining the corrected luminance values of the light emitting diodes of the remaining colors after determining the per-pixel transmittances, if it is judged that there is an illumination area whose luminance value exceeds the luminance value for a surrounding illumination area by a predetermined value, the corrected luminance values are determined after decreasing the luminance value for that illumination area to the predetermined value or less. It should be noted that the elements in common with First Embodiment are given the same reference signs, and a description thereof is omitted below.

Specifically, as shown in FIG. 14, a local dimming calculation unit 6′ of the present embodiment includes a luminance value determination unit 13′ and a transmittance determination unit 14′. The luminance value determination unit 13′ is configured as follows. In each of the first and second subfields, when determining the corrected luminance values of the light emitting diodes of the remaining colors after determining the per-pixel transmittances, if it is judged that there is an illumination area whose luminance value exceeds the luminance value for a surrounding illumination area by a predetermined value, the luminance value determination unit 13′ determines the corrected luminance values after decreasing the luminance value for that illumination area to the predetermined value or less.

To be more specific, the luminance value determination unit 13′ is configured as follows. In the first subfield period, when determining the corrected luminance values of red and blue light emitting diodes on a per illumination area basis based on the input image signal and the per-pixel transmittances determined for the first subfield period, if it is judged that there is an illumination area whose luminance value exceeds the luminance value for a surrounding illumination area by a predetermined value, the luminance value determination unit 13′ determines the corrected luminance values after decreasing the luminance value for that illumination area to the predetermined value or less.

The transmittance determination unit 14′ is configured to determine the per-pixel transmittances using the luminance values of the green light emitting diodes 11g determined by the luminance value determination unit 13′ in the first subfield period, as in First Embodiment.

The luminance value determination unit 13′ is further configured as follows. In the second subfield period, when determining the corrected luminance values of blue light emitting diodes on a per illumination area basis based on the input image signal and the per-pixel transmittances determined for the second subfield period, if it is judged that there is an illumination area whose luminance value exceeds the luminance value for a surrounding illumination area by a predetermined value, the luminance value determination unit 13′ determines the corrected luminance values after decreasing the luminance value for that illumination area to the predetermined value or less.

The transmittance determination unit 14′ is further configured to determine the per-pixel transmittances using the luminance values of the red light emitting diodes 11r determined by the luminance value determination unit 13′ in the second subfield period, as in First Embodiment.

Now, a specific description is given of operations of the liquid crystal display device 1 pertaining to the present embodiment configured in the above manner, with reference to FIGS. 15 through 17. It should be noted that operations of the local dimming calculation device 6′ are mainly discussed in the following description.

FIG. 15 is a flowchart of specific operations performed by the local dimming calculation device shown in FIG. 14 in the first subfield period. FIG. 16 is a flowchart of specific operations performed by the local dimming calculation device shown in FIG. 14 in the second subfield period. FIG. 17 is a flowchart of specific operations performed by the local dimming calculation device shown in FIG. 14 in the third subfield period.

As shown in FIG. 15, the luminance value determination unit 13′ in the local dimming calculation unit 6′ of the present embodiment determines the corrected luminance values of the green light emitting diodes 11g in the illumination areas for the first subfield period, by performing the processing operations of steps S100 through S102 as in First Embodiment. Also, the transmittance determination unit 14′ determines the per-pixel transmittances for the first subfield period by performing the processing operation of step S103 as in First Embodiment.

Next, the luminance value determination unit 13′ determines pre-processing red LED luminance values for the illumination areas with respect to the first subfield period by performing the processing operations of steps S104 and S105 as in First Embodiment.

Thereafter, the luminance value determination unit 13′ decreases the red

LED luminance value for an illumination area to be lit so that, when individually lighting the color red in the illumination area with the corresponding LED luminance value determined in step S105, the luminance values for illumination areas included in its PSF range fall within the corresponding LED luminance values determined in step S105 (step S1051).

Following that, the luminance value determination unit 13′ determines the corrected luminance values of the red light emitting diodes 11r in the illumination areas for the first subfield period by performing the processing operations of steps S106 through S110, as in First Embodiment, with the use of the LED luminance values determined in step S1051. The luminance value determination unit 13′ also determines the corrected luminance values of the blue light emitting diodes 11b in the illumination areas for the first subfield period by performing the processing operation of step S111 as in First Embodiment.

Furthermore, as shown in FIG. 16, the luminance value determination unit 13′ in the local dimming calculation unit 6′ of the present embodiment determines the corrected luminance values of the red light emitting diodes 11r in the illumination areas for the second subfield period, by performing the processing operations of steps 5200 through S203 as in First Embodiment. Also, the transmittance determination unit 14′ determines the per-pixel transmittances for the second subfield period by performing the processing operation of step S204 as in First Embodiment.

Next, the luminance value determination unit 13′ determines the pre-processing blue LED luminance values for the illumination areas with respect to the second subfield period by performing the processing operations of steps S205 and S206 as in First Embodiment.

Thereafter, the luminance value determination unit 13′ decreases the blue LED luminance value for an illumination area to be lit so that, when individually lighting the color blue in the illumination area with the corresponding LED luminance value determined in step S206, the luminance values for illumination areas included in its PSF range fall within the corresponding LED luminance values determined in step S206 (step S2061).

The luminance value determination unit 13′ then determines the corrected luminance values of the blue light emitting diodes 11b in the illumination areas for the second subfield period by performing the processing operations of steps S207 through S211, as in First Embodiment, with the use of the LED luminance values determined in step S2061.

Furthermore, as shown in FIG. 17, the luminance value determination unit 13′ in the local dimming calculation unit 6′ of the present embodiment determines the corrected luminance values of the blue light emitting diodes 11b in the illumination areas for the third subfield period by performing the processing operations of steps S300 through S303 as in First Embodiment. Also, the transmittance determination unit 14′ determines the per-pixel transmittances for the third subfield period by performing the processing operation of step S304 as in First Embodiment.

Now, a specific description is given of the processing operations of steps S1051 through S110 with reference to FIGS. 18A through 22B.

FIGS. 18A through 18C are drawings for explaining one example of processing operations of the luminance value determination unit shown in FIG. 14. FIGS. 19A through 19C are drawings for explaining one example of processing operations of the luminance value determination unit shown in FIG. 14. FIGS. 20A through 20H are drawings for explaining one example of processing operations of the luminance value determination unit shown in FIG. 14. FIGS. 21A and 21B are drawings for explaining one example of processing operations of the luminance value determination unit shown in FIG. 14. FIGS. 22A and 22B are drawings for explaining one example of processing operations of the luminance value determination unit shown in FIG. 14.

The following describes processing operations for a total of 25 illumination areas arranged in 5 rows and 5 columns as shown in FIG. 18A as one example. In the following description, data shown in FIG. 18B is used as the PSF data. That is, as indicated by the 3×3 matrix shown in FIG. 18B, provided that the LED luminance value for the central illumination area targeted for the crosstalk processing is 100%, the luminance of 8 illumination areas surrounding the central illumination area is increased by 25% (according to the PSF data) of the LED luminance value for the central illumination area.

Furthermore, the following description provides an example in which the luminance value determination unit 13′ has determined the red LED luminance values for the 25 illumination areas shown in FIG. 18A by the time the processing operation of step S105 is completed. The determined red LED luminance values are shown in FIG. 18C.

When the red LED luminance values for the 25 illumination areas have been determined as shown in FIG. 18C, the luminance value determination unit 13′ performs the processing operation of step S1051. Specifically, in this processing operation, the LED luminance values for illumination areas surrounding an illumination area with an LED luminance value of “0” are also “0” according to the PSF data. Thereafter, the luminance value determination unit 13′ decreases the red LED luminance value for an illumination area to be lit so that, when individually lighting the color red in the illumination area, the luminance values for illumination areas included in its PSF range fall within the corresponding LED luminance values determined in step S105.

To be more specific, the luminance value determination unit 13′ judges the following illumination areas as the illumination areas whose luminance values exceed the luminance value for a surrounding illumination area by a predetermined value: an illumination area with an LED luminance value of “70” at the fourth row from the top and the first column from the left in FIG. 18C; and an illumination area with an LED luminance value of “90” at the fifth row from the top and the fifth column from the left in FIG. 18C. Here, a predetermined value for the illumination area with the LED luminance value of “70” is the LED luminance value “17.5” which is obtained through predetermined processing using the PSF data thereof (=70×0.25). The luminance value determination unit 13′ judges that, compared to an illumination area with an LED luminance value of “10” which is included among the surrounding illumination areas and is located diagonally to the lower-right of the illumination area with the LED luminance value of “70”, the predetermined value exceeds the calculated LED luminance value “10” for the surrounding illumination area. Then, by using the PSF data, the luminance value determination unit 13′ changes the LED luminance value for the illumination area at the fourth row from the top and the first column from the left in FIG. 18C from “70” to “40” (=10/25 (%)).

Similarly, a predetermined value for the illumination area with the LED luminance value of “90” is the LED luminance value of “22.5” which is obtained through predetermined processing using the PSF data thereof (=90×0.25). The luminance value determination unit 13′ judges that, compared to an illumination area with an LED luminance value of “10” which is included among the surrounding illumination areas and is located diagonally to the upper-left of the illumination area with the LED luminance value of “90”, the predetermined value exceeds the calculated LED luminance value “10” for the surrounding illumination area. It is judged that the luminance value according to PSF thereof exceeds the calculated luminance value for the illumination area. Then, by using the PSF data, the luminance value determination unit 13′ changes the LED luminance value for the illumination area at the fifth row from the top and the fifth column from the left in FIG. 18C from “90” to “40” (=10/25 (%)).

Once the red LED luminance values for the above 25 illumination areas have been determined as shown in FIG. 19A, in the crosstalk processing of step S106, the LED luminance values for illumination areas surrounding an illumination area with an LED luminance value of “0” are also “0” according to the PSF data (i.e. the corresponding light emitting diodes 11r are not lit). Therefore, in the crosstalk processing of step S106, the luminance value determination unit 13′ executes the crosstalk processing with respect to the LED luminance values for the 25 illumination areas shown in FIG. 19A in accordance with the PSF data.

To be more specific, calculation is performed on the LED luminance value for each of the 25 illumination areas shown in FIG. 19A based on the PSF data shown in FIG. 18B, so as to obtain the LED luminance values for 8 surrounding illumination areas as shown in FIG. 19B. Then, the crosstalk processing is performed using the LED luminance values shown in FIG. 19B, and the red LED luminance values for the 25 illumination areas are determined as shown in FIG. 19C.

Specifically, as one example, the LED luminance value “70” for an illumination area at the fourth row from the top and the first column from the left in FIG. 19C is calculated by adding the following LED luminance values: the central LED luminance value “40” of a matrix that is the fourth from the top and the first from the left in FIG. 19B, namely the LED luminance value “40” for this illumination area; the LED luminance value “7.5” for an illumination area immediately below the central LED luminance value “30” of a matrix that is the third from the top and the first from the left in FIG. 19B; the LED luminance value “5” for an illumination area immediately above the central LED luminance value “20” of a matrix that is the fifth from the top and the first from the left in FIG. 19B; the LED luminance value “10” for an illumination area located diagonally to the lower-left of the central LED luminance value “40” of a matrix that is the third from the top and the second from the left in FIG. 19B; the LED luminance value “5” for an illumination area located to the left of the central LED luminance value “20” of a matrix that is the fourth from the top and the second from the left in FIG. 19B; and the LED luminance value “2.5” for an illumination area located diagonally to the upper-left of the central LED luminance value “10” of a matrix that is the fifth from the top and the second from the left in FIG. 19B.

As another example, the LED luminance value “60” for an illumination area at the fifth row from the top and the fifth column from the left in FIG. 19C is calculated by adding the following LED luminance values: the central LED luminance value “40” of a matrix that is the fifth from the top and the fifth from the left in FIG. 19B, namely the LED luminance value “40” for this illumination area the LED luminance value “2.5” for an illumination area located diagonally to the lower-right of the central LED luminance value “10” of a matrix that is the fourth from the top and the fourth from the left in FIG. 19B; the LED luminance value “10” for an illumination area located to the right of the central LED luminance value “40” of a matrix that is the fifth from the top and the fourth from the left in FIG. 19B; and the LED luminance value “7.5” for an illumination area immediately below the central LED luminance value “30” of a matrix that is the fourth from the top and the fifth from the left in FIG. 19B.

Next, the luminance value determination unit 13′ performs the processing operation of step S107. That is, the luminance value determination unit 13′ calculates ratios between red LED luminance values obtained before and after the crosstalk processing, by dividing the post-processing red LED luminance values shown in FIG. 20A by the pre-processing red LED luminance values shown in FIG. 20B. Note that in this calculation processing, the LED luminance values for illumination areas surrounding an illumination area with an LED luminance value of “0” are also “0” according to the PSF data, as shown in FIG. 19A. The result of this processing in step S107 is the data shown in FIG. 20C.

Subsequently, the luminance value determination unit 13′ performs the processing operation of step S108. That is, the luminance value determination unit 13′ judges whether or not the data shown in FIG. 20C includes illumination areas with a ratio of one or more. When judging that there are illumination areas with a ratio of one or more, the luminance value determination unit 13′ finds an illumination area with the largest ratio, and divides the pre-processing red T luminance values for illumination areas included in a PSF range centered around that illumination area by the largest ratio.

More specifically, once the luminance value determination unit 13′ finds an illumination area with the largest ratio “5.5” from the data shown in FIG. 20C, it extracts, from the pre-processing red LED luminance values shown in FIG. 20D, the pre-processing red LED luminance values for illumination areas included in the PSF range centered around that illumination area with the largest ratio. That is, the luminance value determination unit 13′ obtains the LED luminance values for the illumination areas included in the PSF range that are to be divided by the largest ratio “5.5” as shown in FIG. 20F, and performs the division using the largest ratio “5.5”. As a result of the division, the following LED luminance values are obtained: the LED luminance value “7.27” at the fourth row from the top and the third column from the left in FIG. 20E (=40/5.5); the LED luminance value “1.82” at the fourth row from the top and the fourth column from the left in FIG. 20E (=10/5.5); the LED luminance value “5.45” at the fourth row from the top and the fifth column from the left in FIG. 20E (=30/5.5); the LED luminance value “5.45” at the fifth row from the top and the third column from the left in FIG. 20E (=30/5.5); the LED luminance value “7.27” at the fifth row from the top and the fourth column from the left in FIG. 20E (=40/5.5); and the LED luminance value “7.27” at the fifth row from the top and the fifth column from the left in FIG. 20E (=40/5.5)

Next, the luminance value determination unit 13′ performs the processing operation of step S109. That is, the luminance value determination unit 13′ finds an illumination area that is not included in the range for which the division was performed in step S108 and that has the second largest ratio, and divides the pre-processing red LED luminance values for illumination areas included in a PSF range centered around that illumination area by the second largest ratio.

More specifically, once the luminance value determination unit 13′ finds an illumination area with the second largest ratio “4.75” from the data shown in FIG. 20C, it extracts, from the pre-processing red LED luminance values shown in FIG. 20D, the pre-processing red LED luminance values for the illumination areas included in the PSF range centered around that illumination area with the second largest ratio. That is, the luminance value determination unit 13′ obtains the LED luminance values for the illumination areas included in the PSF range that are to be divided by the second largest ratio “4.75” as shown in FIG. 20G, and performs the division using the second largest ratio “4.75”. As a result, the following LED luminance values are obtained: the LED luminance value “8.42” at the fourth row from the top and the first column from the left in FIG. 20E (=40/4.75); the LED luminance value “4.21” at the fourth row from the top and the second column from the left in FIG. 20E (=20/4.75); the LED luminance value “4.21” at the fifth row from the top and the first column from the left in FIG. 20E (=20/4.75); and the LED luminance value “2.11” at the fifth row from the top and the second column from the left in FIG. 20E (=10/4.75).

Following that, the luminance value determination unit 13′ performs the processing operation of step S110. That is, the luminance value determination unit 13′ finds an illumination area that is not included in the ranges for which the division was performed in steps S108 and S109 and that has the third largest ratio, and divides the pre-processing red LED luminance values for illumination areas included in a PSF range centered around that illumination area by the third largest ratio.

More specifically, once the luminance value determination unit 13′ finds an illumination area with the third largest ratio “3.63” from the data shown in FIG. 20C, it extracts, from the pre-processing red LED luminance values shown in FIG. 20D, the pre-processing red LED luminance values for the illumination areas included in the PSF range centered around that illumination area with the third largest ratio. That is, the luminance value determination unit 13′ obtains the LED luminance values for the illumination areas included in the PSF range that are to be divided by the third largest ratio “3.63” as shown in FIG. 20H, and performs the division using the third largest ratio “3.63”. As a result, the following LED luminance values are obtained: the LED luminance value “8.26” at the third row from the top and the first column from the left in FIG. 20E (=30/3.63); and the LED luminance value “11” at the third row from the top and the second column from the left in FIG. 20E (=40/3.63).

Then, once the luminance value determination unit 13′ judges that step S109 has been repeated until all the illumination areas are covered, it performs predetermined crosstalk processing using the red LED luminance values for the illumination areas at that point, thereby calculating the red LED luminance values for the illumination areas.

To be more specific, calculation is performed on the LED luminance value of each of the 25 illumination areas shown in FIG. 21A based on the PSF data shown in FIG. 18B, so as to obtain the LED luminance values of 8 surrounding illumination areas as shown in FIG. 21B. Then, the crosstalk processing is performed using the LED luminance values shown in FIG. 21B as in step S106, and the red LED luminance values for the 25 illumination areas are determined as shown in FIG. 22A. That is, the luminance value determination unit 13′ considers the data shown in FIG. 22A as the corrected luminance values of the red light emitting diodes 11r in the illumination areas for the first subfield period.

Note that the red LED luminance values for the 25 illumination areas shown in FIG. 22A do not exceed the corresponding red LED luminance values for the 25 illumination areas shown in FIG. 22B, which are determined in step S105. Furthermore, in the illumination areas for which the luminance value determination unit 13′ has decreased the LED luminance values in the processing operation of step S1051, namely the illumination area at the fourth row from the top and the first column from the left in FIG. 22A and the illumination area at the fifth row from the top and the fifth column from the left in FIG. 22A, the differences from the original LED luminance values shown in FIG. 22B are “24.1” (=40−15.9) and “29.1” (=40−10.9), respectively.

These values are closer to the original LED luminance values than those of First Embodiment on which the processing operation of step S1051 is not performed. In this way, the liquid crystal display device 1 of the present embodiment can display the color red in accordance with the input image signal more appropriately than that of First Embodiment.

More specifically, according to First Embodiment, in the illumination area at the fourth row from the top and the first column from the left in FIG. 13A and the illumination area at the fifth row from the top and the fifth column from the left in FIG. 13A, the differences from the original LED luminance values shown in FIG. 13B are “50.6” (=70−19.4) and “73.7” (=90−16.3), respectively, and these differences from the original LED luminance values are larger in First Embodiment than in Second Embodiment.

With the above configuration, the present embodiment can achieve effects and advantages similar to those achieved in First Embodiment described above. In addition, the luminance value determination unit 13′ of the present embodiment is configured as follows. In each of the first and second subfields, when determining the corrected luminance values of the light emitting diodes of the remaining colors after determining the per-pixel transmittances, if it is judged that there is an illumination area whose luminance value exceeds the luminance value for a surrounding illumination area by a predetermined value, the luminance value determination unit 13′ determines the corrected luminance values after decreasing the luminance value for that illumination area to the predetermined value or less. As a result, in the present embodiment, the luminance values for the illumination areas can be set at more appropriate values that suppress adverse effects on the surrounding illumination areas, and therefore a decrease in the display quality can be reliably prevented.

It should be noted that all of the above embodiments are illustrative and not restrictive. The technical scope of the present invention is defined by the appended claims, and all changes that come within the range of equivalency of the configurations described in the claims are to be embraced within the technical scope of the present invention.

For example, although the above description has provided an example where the present invention is applied to a transmissive liquid crystal display device, the display device of the present invention is not limited thereto. The present invention may be applied to various types of nonluminous display devices that display information using light from light sources. To be more specific, the display device of the present invention can be suitably used as a semi-transmissive liquid crystal display device or a projection display device such as a rear-projection display device in which the above liquid crystal panel is used for light bulbs.

Although the above description has provided an example where the light emitting diodes of a 3-in-1 type are used (i.e. every light emitting diode is integrally constituted by RGB light emitting diodes), light sources of the present invention are not limited thereto. For example, discharge tubes such as cold cathode fluorescent tubes and hot cathode fluorescent tubes, light emitting elements such as organic electronic luminescence (EL) elements and inorganic EL elements, or a light emitting device such as a plasma display panel, may be used as the light sources.

However, it is preferable to use light emitting diodes as the light sources as in the above embodiments because they consume a small amount of power and enable easy configuration of a display device with excellent environmental properties.

The light emitting diodes of the present invention are not limited to the above light emitting diodes of a 3-in-1 type. Alternatively, it is possible to use R, G, and B light emitting diodes that respectively emit light in colors R, G, and B on an individual basis, or to employ light emitting diodes of a so-called 4-in-1 type (i.e. every light emitting diode is integrally constituted by four light emitting diodes of RGBW, GRGB, and the like). Furthermore, light emitting diodes of any color other than RGBW may be added. In this case, although it is necessary to add colors in the pixel configuration of the liquid crystal panel, a wider range of colors can be reproduced. Specific examples of such colors to be added include yellow and magenta.

Although the above description has provided an example where one frame period is divided into first to third subfield periods, the present invention is not limited in this way or any other way, as long as one frame period is divided into N subfields to display information (N being an integer greater than or equal to three).

It has been described above that, in the first subfield period, the corrected luminance values of the green light emitting diodes are determined on a per illumination area basis, and the per-pixel transmittances for the first subfield period are determined. Likewise, in the second subfield period, the corrected luminance values of the red light emitting diodes are determined on a per illumination area basis, and the per-pixel transmittances for the second subfield period are determined. In the third subfield period, the corrected luminance values of the blue light emitting diodes are determined on a per illumination area basis, and the per-pixel transmittances for the third second subfield period are determined. However, the present invention is by no means limited in this way.

However, it is preferable to determine the corrected luminance values of the green light emitting diodes on a per illumination area basis in the first subfield period as in the above embodiments. In this way, red and blue can be mixed on the basis of green that has the highest luminosity factor among the colors red, green, and blue; accordingly, the color breakup phenomenon can be reliably suppressed.

In addition, it is preferable to determine the corrected luminance values of the red light emitting diodes on a per illumination area basis in the second subfield period. In this way, blue can be mixed on the basis of red that has a relatively higher luminosity factor than blue; accordingly, the color breakup phenomenon can be suppressed more reliably.

Although the above has described a configuration for proceeding with the first, second, and third subfield periods in sequence, the present invention is not limited in this way. Alternatively, it is possible to have a configuration in which, after the luminance values and transmittances have been calculated for the first to third subfield periods, display operations are performed in the second, first, and third subfield periods.

The present invention is useful when applied to a display device that can achieve a further reduction in power consumption.

1. A display device that includes a backlight unit and a display unit and displays information with one frame period divided into N subfield periods (N being an integer greater than or equal to three), the backlight unit having light sources, and the display unit having a plurality of pixels and displaying information using illumination light from the backlight unit, the display device comprising:
a plurality of display areas set in the display unit;
a plurality of illumination areas set in the backlight unit to make light from the light sources incident on the respective display areas; and
a control unit that controls driving of the backlight unit and the display unit using an input image signal, wherein
light sources of multiple colors are provided in the backlight unit on a per illumination area basis, the light sources of multiple colors emitting light in multiple colors that can be mixed with white light, and
the control unit includes a local dimming calculation unit that, in each of the N subfield periods, calculates luminance values based on the input image signal on a per illumination area basis and on a per light source basis, and calculates per-pixel transmittances based on determined luminance values.

2. The display device according to claim 1, wherein
the local dimming calculation unit includes:
a luminance value determination unit that, in each of the N subfield periods, calculates luminance values of light that is from the illumination areas and incident on the corresponding display areas on a per light source basis based on the input image signal, corrects the calculated luminance values on a per illumination area basis using luminance values for surrounding illumination areas, and determines the corrected luminance values as luminance values of the corresponding light sources; and
a transmittance determination unit that, in each of the N subfield periods, determines per-pixel transmittances using luminance values of any of the light sources of multiple colors determined by the luminance value determination unit.

3. The display device according to claim 2, wherein the luminance value determination unit determines the corrected luminance values using data of a predetermined point spread function (PSF) on a per light source basis and on a per illumination area basis.

4. The display device according to claim 2, wherein
first, second, and third subfield periods are used as the N subfield periods,
red, green, and blue light emitting diodes that respectively emit light in colors red, green, and blue are used as the light sources of multiple colors,
in the first subfield period, the luminance value determination unit determines, on a per illumination area basis, the corrected luminance values of light emitting diodes corresponding to one color among the colors red, green, and blue based on the input image signal,
the transmittance determination unit determines per-pixel transmittances for the first subfield period using the determined corrected luminance values of the light emitting diodes corresponding to one color,
the luminance value determination unit determines, on a per illumination area basis, the corrected luminance values of light emitting diodes corresponding to the remaining two colors among the colors red, green, and blue based on the input image signal and the determined per-pixel transmittances for the first subfield period,
in the second subfield period, the luminance value determination unit determines, on a per illumination area basis, the corrected luminance values of light emitting diodes corresponding to one of the remaining two colors among the colors red, green, and blue based on the input image signal,
the transmittance determination unit determines per-pixel transmittances for the second subfield period using the determined corrected luminance values of the light emitting diodes corresponding to one of the remaining two colors,
the luminance value determination unit determines, on a per illumination area basis, the corrected luminance values of light emitting diodes corresponding to the other of the remaining two colors based on the input image signal and the determined per-pixel transmittances for the second subfield period,
in the third subfield period, the luminance value determination unit determines, on a per illumination area basis, the corrected luminance values of the light emitting diodes corresponding to the other of the remaining two colors based on the input image signal, and
the transmittance determination unit determines per-pixel transmittances for the third subfield period using the determined corrected luminance values of the light emitting diodes corresponding to the other of the remaining two colors.

5. The display device according to claim 4, wherein
in the first subfield period, the luminance value determination unit determines, on a per illumination area basis, the corrected luminance values of the green light emitting diodes based on the input image signal, and
the transmittance determination unit determines the per-pixel transmittances for the first subfield period using the determined corrected luminance values of the green light emitting diodes.

6. The display device according to claim 5, wherein
in the second subfield period, the luminance value determination unit determines, on a per illumination area basis, the corrected luminance values of the red light emitting diodes based on the input image signal, and
the transmittance determination unit determines the per-pixel transmittances for the second subfield period using the determined corrected luminance values of the red light emitting diodes.

7. The display device according to claim 2, wherein
in the first subfield period, when determining the corrected luminance values of light emitting diodes corresponding to the remaining two colors among colors red, green, and blue on a per illumination area basis based on the input image signal and determined per-pixel transmittances for the first subfield period, if it is judged that there is an illumination area whose luminance value exceeds the luminance value for a surrounding illumination area by a predetermined value, the luminance value determination unit determines the corrected luminance values after decreasing the luminance value to the predetermined value or less, and
in the second subfield period, when determining the corrected luminance values of light emitting diodes corresponding to the other of the remaining two colors on a per illumination area basis based on the input image signal and determined per-pixel transmittances for the second subfield period, if it is judged that there is an illumination area whose luminance value exceeds the luminance value for a surrounding illumination area by a predetermined value, the luminance value determination unit determines the corrected luminance values after decreasing the luminance value to the predetermined value or less.
